(19) United States
(12) Patent Application Publication
(10) Pub. No.: US 2024/0254150 A1
(43) Pub. Date: Aug. 1, 2024

(54) CONFORMATIONALLY RESTRICTED SULFONATE BASED PHOSPHINE LIGANDS FOR HINDERED SUZUKI COUPLING REACTIONS

(71) Applicant: TCG GreenChem Inc., Ewing, NJ (US)

(72) Inventors: Arun Dixith Reddy SHADA, Plainsboro, NJ (US); Hari Prasad Reddy MANGUNURU, Henrico, VA (US); Gopal SIRASANI, Pennington, NJ (US); Bo QU, Brookfield, CT (US); Chris Hugh SENANAYAKE, Brookfield, CT (US); Srinivasarao TENNETI, Plainsboro, NJ (US)

(73) Assignee: TCG GreenChem Inc., Ewing, NJ (US)

(21) Appl. No.: 18/394,056

(22) Filed: Dec. 22, 2023

Related U.S. Application Data
(60) Provisional application No. 63/477,589, filed on Dec. 29, 2022.

(51) Int. Cl. C07F 9/50; B01J 23/44

(52) U.S. Cl. CPC C07F 9/5004; B01J 23/44

(57) ABSTRACT

The present disclosure provides a series of novel, water-soluble, sulfonate-based phosphorus ligand of formula (I) derived from a dihydrobenzo 1,3-oxaphosphole framework that has shown superior results for Suzuki coupling reactions for hindered substrates in aqueous media.

### TECHNICAL FIELD

The present invention relates to a series of novel, water-soluble phosphorus ligand for cross-coupling reactions. More particularly, the present invention relates to synthesis and characterization of highly competent new conformationally restricted sulfonate-based phosphorus ligand for sterically hindered Suzuki-Miyaura coupling reactions in largely aqueous media.

### BACKGROUND ART

The Suzuki-Miyaura coupling is one of the most useful methods for formation of carbon-carbon bonds and has been used in numerous synthetic ventures since its inception and narration in articles N. Miyaura et. al.: Topics in Current Chem. 2002, 219, 11; and A. Suzuki et. al.: Organomet.Chem.1999, 576, 147. Further developments in this field of chemistry shows that palladium-catalyzed Suzuki-Miyaura cross-coupling reaction has advanced into one of the most powerful carbon-carbon bond-forming reactions that have been applied successfully on commercial scales for the synthesis of key intermediates and active ingredients in the pharmaceutical and agriculture arena [as recited in articles such as P. Devendar et. al.: J. Agric. Food Chem.2018, 66, 8914-8934; I. T. L. Ramoset. al.: Synth. Commun.2021, 51, 3520-3545; Z. Z. Zhoun et. al.: Inorg. Chem. Commun. 14 (2011) 659-662; M. Amini et. al.: Chem. Pap. 67 (2013) 759-763; M. Amini et. al.: Chin. Chem. Lett. 24 (2013) 433-436]. As a result, the palladium-catalyzed-Suzuki-Miyaura reaction has garnered immense interest among the synthetic research community to continue investing in identifying sustainable conditions in new effective catalysts and solvent systems.

In any chemical process, including Suzuki-Miyaura coupling reactions, solvents play an essential role in deciding its environmental impact as well as its cost, safety and health issues. Organic solvents are often toxic, highly flammable, volatile, and non-renewable and have low heat capacities. In contrast, water is non-toxic and non-flammable, has a high heat capacity, and is relatively cheap, so it would appear to be an attractive solvent [as recited in articles H. D. Velazquezd et. al.: Chem. Soc. Rev. 41 (2012) 7032-7060; C. J. Li et. al.: Chem. Rev. 105 (2005) 3095-3166; and K. Shaughnessy et. al.: Chem. Rev. 109 (2009) 643-710].

Generally, as known in the relevant art, any improvement of palladium-catalyzed reactions is based largely on the reactivities of the palladium catalyst by using efficient supporting ligands. Such ligands have been described in some prior arts such as S. Mohanty et. al: Tetrahedron 64 (2008) 240-247; X. Q. Zhang et. al.: Organometallics 28 (2009) 3093-3099; and B. P. Morgan et. al.: Dalton Trans. (2009) 2020-2028. Therefore, during the past decades many efforts have been made to find the most efficient phosphine-based ligands that are used for the Suzuki coupling reactions. However, as recited in articles N. G. Andersen et. al.: Chem. Rev. 101 (2001) 997-1030; and R. Martin et. al.: Acc. Chem. Res. 41 (2008) 1461-1473, most of the phosphine-based ligands of prior arts are requiring high load of palladium catalyst in 5-10 mol % in organic solvent.

Further, many non-sulfonated phosphine ligands have been disclosed in some prior arts like Chris H. Senanayake et. al.: Organic Letters (2011), 13(6), 1366-1369; Bo Qu et. al.: Angewandte Chemie, International Edition (2010), 49(34), 5879-5883; Sonia Rodriguez et. al.: Adv. Synth. Catal. 2011, 353, 533-537; Nitinchandra D. Patel et. al.: Asian J. Org. Chem. 2017, 6, 1285-1291; U.S. Pat. No. 9,096,626B2; U.S. Ser. No. 10/683,256B2; U.S. Pat. No. 8,895,737B2 having their utility in transition metal catalyzed cross-coupling reactions. However, these prior arts do not explicitly deal with Suzuki coupling reactions of the sterically hindered substrates in green environment. Moreover, none of these prior arts relate to sulfonate containing phosphine ligands, leave alone providing any information on their utilization in largely water based hindered Suzuki Coupling reactions.

Few prior arts that disclose sulfonated phosphine ligands like Buchwald et. al.: Org. Lett. 2021, 23,777-780; U.S. Pat. No. 6,140,265 fail to provide any conformationally locked ligand, since, in most these prior arts the phosphine is freely rotating. Hence, these prior reported sulfonated phosphine ligands are not effective in hindered C-C or C-N coupling reactions, leave alone dealing with such coupling reactions in largely aqueous media. Moreover, these prior arts demand a high ligand loading; therefore, are not economically feasible for C-C hindered Suzuki Coupling reactions in industrial scales.

Therefore, there is still a requirement in the art to design and develop new phosphine ligands that are water soluble; and at the same time are highly efficient for palladium-catalyzed hindered Suzuki-Miyaura Coupling reactions. Accordingly, the inventors of the current invention have developed a novel series of water-soluble, conformationally locked, sulfonate containing phosphine ligands that can be effectively utilized in Pd-catalyzed Suzuki-Miyaura reactions for sterically hindered substrates in aqueous media, albeit with a low ligand loading of 0.1-1.0 mol % and a low catalyst loading of 0.1-1.0 mol % palladium.

### SUMMARY OF THE INVENTION

An object of the invention is to overcome the disadvantages of the prior art.

Another object of the present invention is to provide a novel, water-soluble, sulfonate containing phosphorus ligand of formula (I) and racemates, enantiomers, atropo-diastereomers and pharmaceutical salts thereof, having effective utilization in Pd-catalyzed hindered Suzuki-Miyaura Coupling reaction in aqueous media:

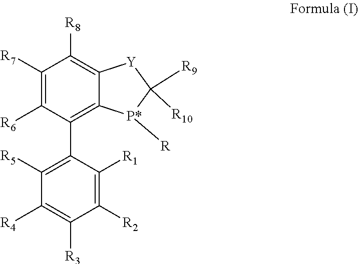

wherein, at least any one of R1, R2, R3, R4, R5, R6, R7, R8, R9, R10 is essentially a sulfonyl moiety of formula (X)

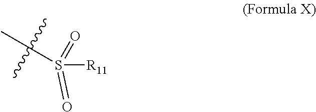

Another object of the present invention is to provide a novel, water-soluble, sulfonate-based phosphorus ligand of formula (I) and racemates, enantiomers, atropo-diastereomers and pharmaceutical salts thereof, having effective utilization in Pd-catalyzed hindered Suzuki-Miyaura Coupling reaction with a low ligand loading of 0.1.-1.0 ml % along with a low catalyst loading of 0.1-1.0 mol % palladium.

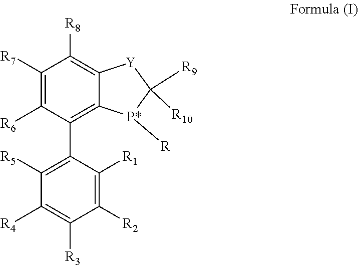

wherein, at least any one of R1, R2, R3, R4, R5, R6, R7, R8, R9, R10 is essentially a sulfonyl group of formula (X)

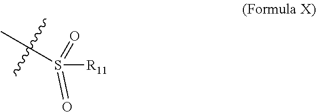

Another object of the present invention is to provide a novel, water-soluble phosphorus ligand of formula (I) above providing 90-100% C-C conversion in an economical way.

The present invention provides a series of novel, water-soluble, sulfonate-based phosphorus ligand of formula (I) derived from a sulfonate-substituted dihydrobenzo-1,3-oxaphosphole framework that has shown superior results for Suzuki coupling reactions for sterically hindered substrates in aqueous media.

Further benefits of this disclosure will be apparent to one skilled in the art.

### BRIEF DESCRIPTION OF THE DRAWINGS

FIG. 1(a) graphically illustrates the ¹H NMR data (600 MHz, CD₃OD) of major isomer of CS-Phos; FIG. 1(b) graphically illustrates the ¹³P NMR analytical data that shows the formation of atrop-diastereomers of the currently developed sulfonate containing phosphine ligands (CSPhos and mono-CSPhos); FIG. 1(c) graphically illustrates the 2-D (NOESY) NMR data which confirms the formation of the two atrop-diastereomers; FIG. 1(d) graphically illustrates the V. T. NMR experimental data which determines presence of two sets of signals due to two rotamers (i.e. atropisomers); FIG. 1 (e) graphically illustrates the ¹³P NMR analytical data confirming formation of the current mono-CSPhos ligand; and FIG. 1 (f) graphically illustrates the ¹H NMR data confirming formation of the current mono-CSPhos ligand;

FIG. 2 illustrates the reaction profiles of Suzuki-Miyaura coupling reactions of various sterically hindered aryl halides and heteroatomic moieties, using currently developed ligand CSPhos in the presence of TBAB or Tetraglyme as PTC;

FIG. 3 graphically illustrates the ¹H NMR (400 MHz, CDCl₃) data, confirming formation of Boscalid (first step);

FIG. 4 graphically illustrates the ¹H NMR (400 MHz, CDCl₃) data, confirming formation of compound 4q (Etoricoxib).

### DETAILED DESCRIPTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

It should be emphasized that the term “alkyl” when used in this specification refers to any n-(C₁-C₆)alkyl, tertiary-(C₁-C₆)alkyl [preferably, tert-butyl], any cyclohexyl, triethylmethine, dimethylethylmethine, diethylmethylmethine;

The present invention relates to a series of novel, sulfonate based conformationally locked, efficient phosphorus ligand of formula (I) for sterically hindered Suzuki-Miyaura coupling reactions in water.

An embodiment of the present invention provides a novel, water-soluble, sulfonate based phosphorous ligand of formula (I) and racemates, enantiomers, atrop-diastereomers and pharmaceutical salts thereof, for a Pd-catalyzed sterically hindered Suzuki-Miyaura Coupling reaction in aqueous media:

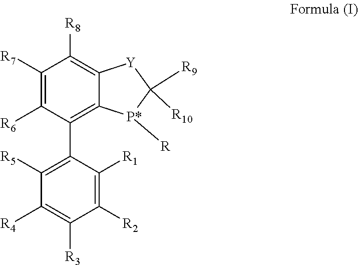

wherein, R is (C₁-C₆)-alkyl, CF₃, (C₃C₁₀)-carbocyclyl, (5 to 11-membered)heterocarbocyclyl, (C₆-C₁₀)aryl, (5 to 11-membered)heteroaryl, ferrocenyl, wherein each such carbocyclyl, heterocarbocyclyl, aryl, ferrocenyl or heteroaryl group is optionally substituted with 1 to 3 substituents independently selected from the group consisting of H, —O—(C₁-C₆)alkyl, (C₁-C₆)alkyl, and CF₃;
P* is a chiral centre;
Y is O, S, CH2, NRₐ, SO₂R_{b},
   wherein Rₐ is alkyl, aryl, heteroaryl, acyl preferably tert-butylacyl; further
   wherein R_{b} is alkyl, aryl, heteroaryl;
R1, R2, R3, R4, R5, R6, R7, R8, R9 and R10 is selected from a group consisting of H, halo, CF3, a sulfonyl moiety, (C₁-C₆)-alkyl, —O—(C₁-C₆)-alkyl, (C₆-C₁₀)aryl, —O—(C₆-C₁₀)aryl, (C₅-C₁₁) heteroaryl, —O—(C₅-C₁₁) heteroaryl, wherein each such alkyl, aryl or heteroaryl group is optionally substituted with 1 to 3 substituents independently selected from the group consisting of H, (C₁-C₆)-alkyl, halo, —O—(C₁-C₆)alkyl and CF₃; further wherein, at least any one of R1, R2, R3, R4, R5, R6, R7, R8, R9 and R10 is essentially a sulfonyl moiety of formula (X)

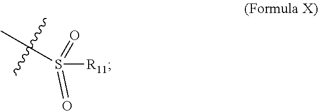

R11 is O or N or a metal atom further substituted with a substituent selected from a group consisting of H, a metal atom, substituted or unsubstituted (C₁-C₆)alkyl, substituted or unsubstituted (C₆-C₁₀)aryl, substituted or unsubstituted (C₅-C₁₁)heteroaryl, NRxRyRz, (C₁-C₆)alkyl-NRxRyRz,
wherein,
said metal atom is an alkali metal atom, preferably Li, Na, K, Cs; and
each one of Rx, Ry and Rz is H, halo, CF3, (C₁-C₆)-alkyl, —O—(C₁-C₆)-alkyl, (C₆-C₁₀)aryl, (C₅-C₁₁) heteroaryl, —O—(C₅-C₁₁) heteroaryl or
Rx, Ry and Rz taken together with the adjacent N atom can form a 5-11 membered heterocylic ring system which can further be substituted with H, (C₁-C₆)-alkyl, halo, —O—(C₁-C₆)alkyl and CF3.

In a particular embodiment of the present invention and in connection with the above, the inventors have found that when particularly Y is O; R is —C(CH₃)₃; R1, R2, R3, R4, R5, R6, R7, R8, R9 and R10 is —(C₁-C₆)-alkyl or —O—(C₁-C₆)-alkyl, preferably —CH₃, —CH₂CH₃, —CH(CH₃)₂ or —O—CH₃, with a condition such that at least any one of the other R1, R2, R3, R4, R5, R6, R7, R8, R9 and R10 is essentially a sulfonyl moiety of formula (X)

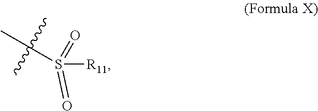

then a new class of highly effective sulfonate based, benzooxaphosphole water-soluble ligands are produced which are particularly useful in the application of Suzuki-Miyaura cross-coupling reactions for the sterically hindered substrates in aqueous media. It has also been observed that the catalytic activities of such coupling reactions are greatly enhanced by the addition of catalytic amount of organic phase transfer reagents catalysts. Further, this procedure can be conducted with low catalyst loading and provides a practical solution for these reactions. Furthermore, the viability of this new class of highly effective sulfonate based, benzooxaphosphole water-soluble ligands in Suzuki Miyaura coupling reactions is demonstrated with various substrates to generate important building blocks including heterocycles for synthesis of biologically active compounds. Accordingly, the inventors of the present invention have found that a sulfonate series of the following chiral phosphorous ligands (mono-CSPhos and CS-Phos) are water soluble in nature and at the same time are highly effective in Suzuki coupling reactions for hindered substrates in aqueous media:

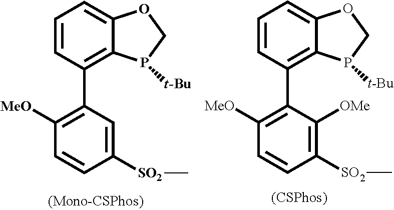

In yet another embodiment of the present invention, the sterically demanding substrates are chosen from the class of aryl halide, arylboronic acid and heteroaryl halides.

Accordingly, such substrates can be selected from a group consisting of 1-bromo-2,4,6-triisopropylbenzene, 1-bromo-2-nitrobenzene, 1-bromo-2-methylnaphthalene, methyl-2-bromo-3-methylbenzoate, 2-bromo-1,3,5-triisopropylbenzene, 2-bromo-1,3,5-tri-tert-butylbenzene, [1,1′-biphenyl]-2-ylboronic acid, 2-fluoro-6-methoxyphenyl-boronic acid, thianthren-1-ylboronic acid, 2,6-dimethylphenyl-boronic acid or 2-bromopyridine, specifically 1-bromo-2,4,6-triisopropylbenzene and biphenyl boronic acid are tested for Suzuki cross-coupling reaction in water using the sulfonated phosphorous ligands as developed in the present invention.

Further, in another embodiment of the present invention, the inventors have additionally used a Phase Transfer Catalyst (PTC) in the same reaction scheme 2 (as above) in order to achieve complete C-C conversions. The PTCs used in the present invention is selected from a group consisting of tetrabutyl ammonium bromide (TBAB), tetrabutyl ammonium iodide, tetrabutyl ammonium chloride, tetrabutyl ammonium hexafluorphosphate and other quaternary amine salts, Triethanolamine tris(2-methoxyethyl) ether (TDA-1), 18-Crown-6, 15-crown-5, Dimethoxyethane (DME), Glyme, Diglyme, Triethylene glycol dimethyl ether (Triglyme), Tetraethylene glycol dimethyl ether (Tetraglyme), 1,4-Dioxane, and tetrahydrofuran.

Another important embodiment of the present invention provides a sterically hindered, Suzuki-Miyaura Coupling process in aqueous media comprising the steps of: a) reacting two sterically hindered substrates chosen from above, in presence of a Palladium (Pd)-based catalyst such as Pd(OAc)₂, Pd₂(dba)₃, Pd(PPh₃)₄ or palladacycles; b) essentially adding the novel, water-soluble sulfonate based phosphorous ligand of the present invention; further c) adding a base such as K₂CO₃, K₃PO₄, Na₂CO₃ or Na₃PO₄; d) a Phase Transfer catalyst (PTC) chosen from the options above; and e) water. It is surprisingly observed that even with only 0.1-1 mol % of Pd catalyst, and in presence of only 0.1-1 mol % the current ligand, an efficient C-C bond conversion (99-100%) is achieved in an aqueous media.

Interestingly, in the present invention, the inventors have evaluated the reactivity profile of the currently developed, water-soluble sulfonated CSPhos ligand towards hindered Suzuki-Miyuara coupling reactions in water. While doing so they have tested various combinations of the amounts of reactants and/or the other experimental parameters and/or effect of solvents in order to select the best working experimental conditions that are required for achieving a complete 99-100% C-C conversion at an economical rate. The detailed study and analysis of the same have been provided in examples below.

Further, it has been found in the present invention that the introduction of sulfonate group onto (R)-3-(tert-butyl)-4-(2,6-dimethoxyphenyl)-2,3-dihydrobenzo[d][1,3] oxaphosphole ligand derivatives has the potential to be advantageous for effectively running a C-C coupling reaction in water or water containing organic solvents; therefore, these ligands provide a practical solution for running the Suzuki-Miyaura coupling reactions in a green environment and in a sustainable manner for synthesizing various commercially available APIs in pharmaceutical industries such as Boscalid Etoricoxib etc.

Advantages of the currently developed mono-CSPhos and CSPhos ligands of the present invention have been provided below:
The current ligand CSPhos as compounds ‘per se’ is new, water-soluble, and stable for large scale hindered Suzuki-Miyaura couplings reactions in aqueous media; hence supports green chemistry. The diastereomeric pure ligand CSPhos can also be applied in enantio-selective Suzuki coupling reactions.
In contrast to the water-soluble biaryl ligands reported by Buchwald and co-workers, which have shown poor reactivity towards hindered coupling reactions, the present ligand CSPhos exhibits superior reactivity, yield, and conversion rates.
The current invention advantageously shows that using TBAB and Tetraglyme as PTCs provides the best results for hindered coupling reactions.
Besides an extensive substrate scope which includes various sterically congested aryl halides, the present invention also demonstrates the superior performance of the currently developed CSPhos ligand in various heteroatom coupling reactions.
The currently developed CSPhos ligand provides 100% conversion rate in a hindered Suzuki-Miyaura coupling reaction in aqueous media using a very low ligand loadings (0.1-1.0 mol %) along with low Pd catalyst loading (0.1.-1.0 mol %); hence is economical.
Further, this new CSPhos ligand is capable of performing coupling reactions at a large scale (>1 g); hence is industrially viable.
The present invention thus provides an easily accessible water-soluble ligand with the potential of performing hindered coupling reactions with 100% conversion rate in an economical way; hence, is promising for practical applications in large-scale synthesis in transition-metal catalyzed coupling reactions.

The invention is now illustrated by way of non-limiting examples. The examples are intended to be purely exemplary of the invention, should therefore not be considered to limit the invention in any way.

### EXAMPLES

### Example 1: Synthesis of the Currently Developed Sulfonate-Based Phosphorus Ligands (Mono-CSPhos and CSPhos) of the Present Invention

Example 1 illustrates processes for synthesizing new, purified, water-soluble, sulfonate-based phosphorous ligands of the present invention following the scheme 1 below:

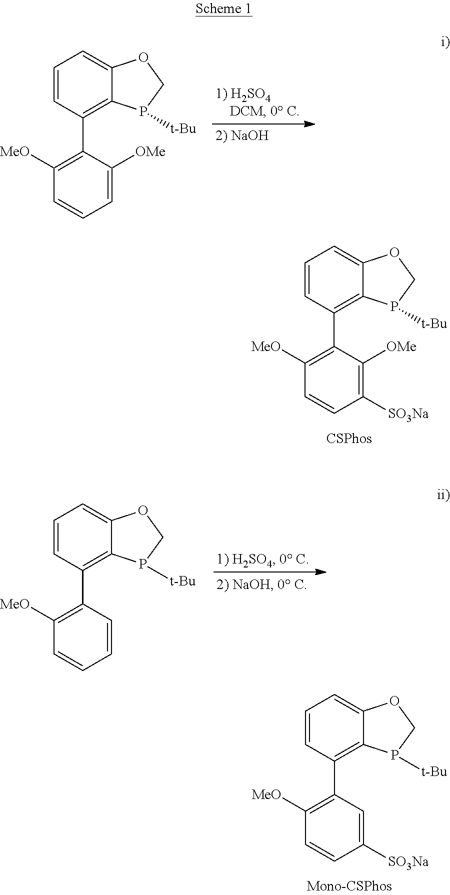

Based on the above reaction scheme 1(i) and (ii), the detailed processes for synthesizing the ligands of the present invention have been provided below:

### General Methods:

All reactions are carried out under a nitrogen atmosphere unless otherwise specified. THF (<0.02% water content), CH₂Cl₂, hexanes, n-butanol, dioxane, and toluene are purchased from Millipore Sigma and used directly without further purification. Concentrated H₂SO₄ is ordered from TCI America and used directly. Boronic acid and alkyl halides are purchased from Millipore Sigma and Ambeed and used without further purification.

¹H, ³¹P and ¹³C NMR data are recorded on a Bruker-Biospin DRX500 or DRX400 NMR Spectrometer with CDCl₃ or CD₃OD as the solvent. ¹H shifts are referenced to CDCl₃ at 7.26 ppm. ³¹P shifts are referenced to 85% H₃PO₄ in D₂O at 0.0 ppm as external standard and obtained with ¹H decoupling. ¹³C shifts are referenced to CDCl₃ at 77 ppm and obtained with 1 H decoupling. The reactions are monitored by thin-layer chromatography (TLC) using silica gel GF₂₅₄. Whenever required, structural assignments are made with additional information from gCOSY, gHSQC, gHMBC, and NOESY experiments. A JEOL JMS T100LC AccuTOF™ mass spectrometer with lonsense DART ion source, controlled by Mass Center software version 1.3.4 m (JEOL Inc., Tokyo, Japan), is used to analyze all samples. If the samples are dry, they are dissolved in 1 ml of methanol. Briefly, a capillary tube is dipped three times into an aliquot of each sample prior to being introduced into the helium stream of the DART mass spectrometer. Each sample is analyzed in positive-ion mode with a helium stream temperature of 300° C. Orifice 1 is operated at 20 V with the range of masses measured being m/z 40-1100. Each sample is analyzed three to five separate times to ensure the reproducibility of the results. The data are analyzed by the creation of averaged, background-subtracted, centroided mass spectra that are calibrated using PEG 600 with T.S.S Pro 3.0. Melting points for the compounds are determined using differential scanning calorimetry (DSC). DSC curves are recorded in a DSC 3+ STAR System (Mettler Toledo) using aluminum standard 40 μL crucibles containing ˜2 mg of samples under a dynamic nitrogen atmosphere (50 mL min⁻¹) and a heating rate of 10° C. min⁻¹ in the temperature range of 25 to 400° C.

### Procedure (i): Preparation of Water-Soluble Ligand CSPhos

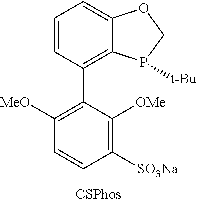

A 50 mL three-neck round-bottomed flask (RB) equipped with a magnetic stir bar under N₂ is charged with (S)-3-(tert-butyl)-4-(2,6-dimethoxyphenyl)-2,3-dihydrobenzo[d][1,3]oxaphosphole (BIDIME) (5.0 g, 15.1 mmol) and CH₂Cl₂ (20 mL). The solution is cooled to 0° C. using an ice/water bath, and then concentrated H₂SO₄ (8.2 mL, 151.1 mmol 10.0 equiv) is added dropwise. The solution slowly turns yellow in color. The solution is then allowed to stir for 2 hrs. Upon confirmation of the product formation by ³¹P NMR, the reaction is quenched by the dropwise addition of NaOH (50 mL, 300.0 mmol, 20.0 equiv, 6 M solution) into the reaction mixture via syringe over the course of ˜10 min (pH ˜7.0 as judged by pH paper) and the mixture is vigorously stirred for 1 hour. The aqueous solution is extracted with CH₂Cl₂ (3×30 mL) and concentrated under reduced pressure, resulting in a flaky white solid (5.6 g, 86%).

### Results

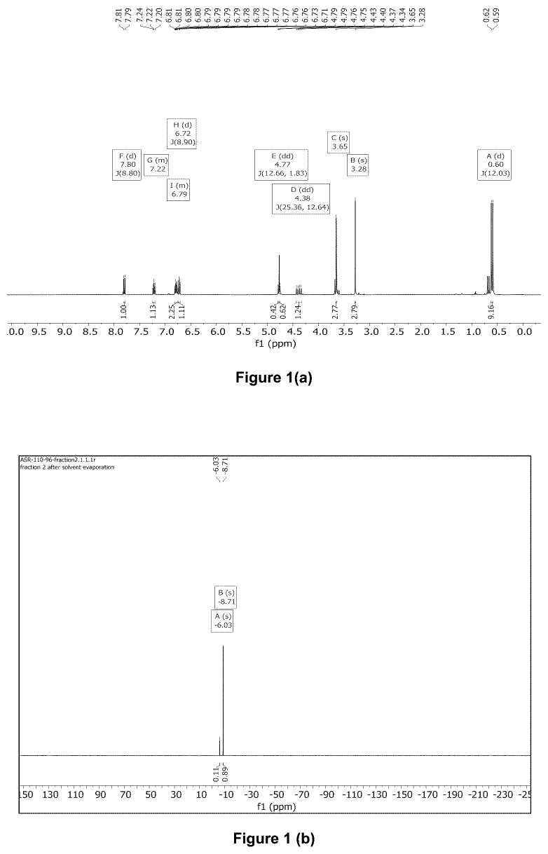

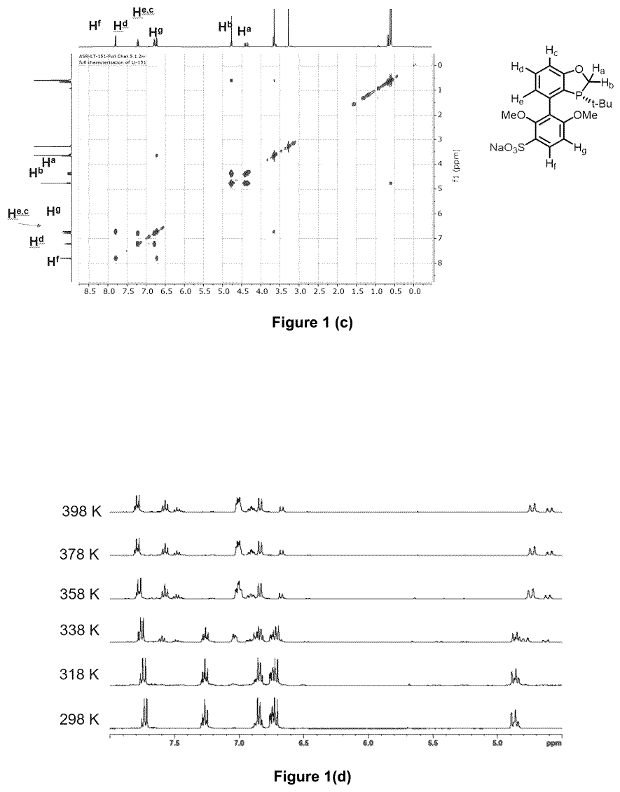

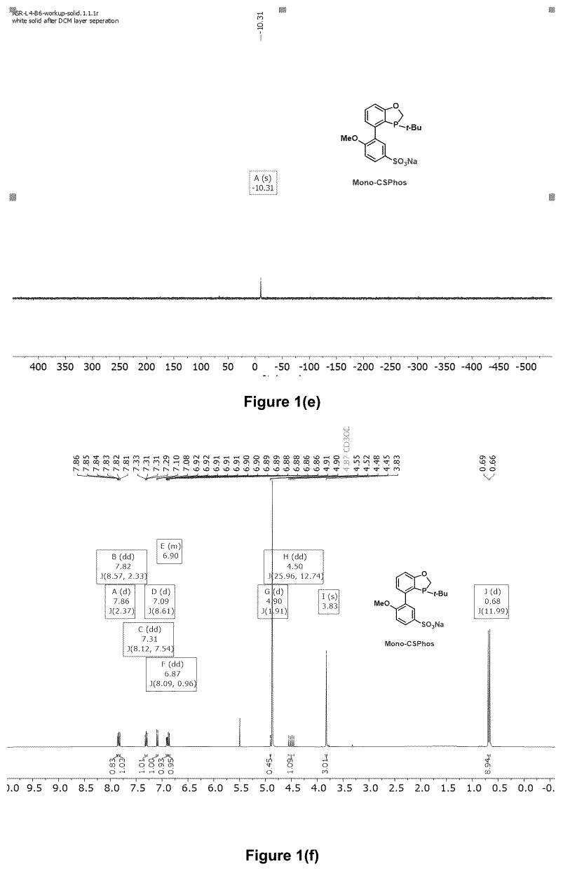

a)¹H NMR data (600 MHz, CD₃0D): 5 7.90 (d, J=8.8 Hz, 1H), 7.33 (t, J=7.8 Hz, 1H), 6.90 (dd, J=7.8, 2.3 Hz, 1H), 6.89 (d, J=8.0 Hz, 1H), 6.83 (d, J=8.9 Hz, 1H), 4.88 (dd, J=12.7, 1.8 Hz, 1H), 4.48 (dd, J=25.4, 12.6 Hz, 1H), 3.76 (s, 3H), 3.38 (s, 3H), 0.71 (d, J=11.9 Hz, 9H). This data as illustrated in accompanying FIG. 1(a) confirms the formation of the sodium sulfonate-based phosphorus ligand (CSPhos) of the present invention.
b) The results obtained by ³¹P NMR as depicted in accompanying FIG. 1(b) illustrates formation of one major peak A at 5=−6.03 ppm along with a small peak B at 10% in the isolated compound; this confirms the formation of the current sodium sulfonate ligand CSPhos. It is also observed that the ratio of the two resonances did not vary with reaction temperature (−20° C. vs 10° C.). The ratio of major to minor diastereomer is consistently observed at 9:1 in the isolated ligand.
c) Further, an extensive ^{2-D}NMR (NOESY) study [as shown in accompanying FIG. 1(c)] is performed on the said isolated mixture, which confirms that the two signals have resulted from the restricted rotation of the biaryl C—C bond that have led to the formation of the two atrop-diastereomers.

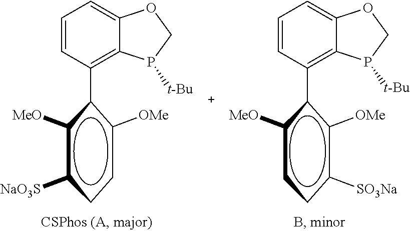

d) Moreover, a clear splitting pattern on the bottom ring of both components shows the sulfonation preferably occurs on the bottom phenyl ring of the current CSPhos ligand.
e) Further, a V. T. NMR experiment is employed to determine whether two sets of signals are due to two rotamers (i.e., atropisomers). Generally, at a specific temperature, signals from both compounds should merge into one set. But as shown in accompanying FIG. 1(d), as the temperature increases, the signals are found to shift for both isomers, but a merging of the signal is not found. At higher temperatures (>358 K), isomers oxidized and formed phosphine oxide, but still, both isomers are not merged even at 398 K (125° C.). This experiment indicates that these compounds are just a kind of positional isomers or can be considered diastereomeric atropisomers because diastereomer signals do not merge in the VT experiment and do not show exchangeable signals in NOESY NMR.

### Procedure (ii): Preparation of Water-Soluble Ligand Mono-CSPhos

A Schlenk flask equipped with a magnetic stir bar is charged with Phosphine (0.3 g, 1.0 mmol) under an argon atmosphere, followed by the addition of Sulfuric acid (2.68 mL, 50.0 equiv) by glass syringe at 0° C. The reaction tube is capped with a screw cap lined with a PTFE septum, and the yellow biphasic reaction mixture is vigorously stirred at 0° C. for 2 hours. Then the reaction is quenched at 0° C. by 6 M NaOH until the solution becomes basic (pH>10), and the reaction is let to stir for 1 hour at 0° C. The product is extracted by 60 mL DCM and concentrated under reduced pressure. This results into a creamy white solid which is confirmed to be the phosphine oxide. It is thus observed that the reaction of mono methoxy ligand with concentrated sulfuric acid results in the formation of a sulfonated ligand, followed by the immediate formation of the phosphine oxide. Next the reaction is conducted under argon, using neat H₂SO₄ as the solvent for 2 hours, and working up the reaction under argon results in the complete formation of the new product confirmed by ³¹P NMR. Then the reaction is quenched at 0° C. by NaOH, and the product is extracted with DCM to provide mono-CSPhos as a white flaky solid (0.3 g, 79%). The reaction progress and formation of the final product having the structure below is monitored by ³¹P NMR and ¹H NMR:

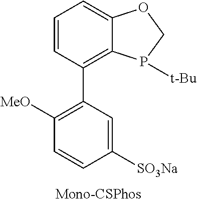

### Results

a) The results obtained by ³¹P NMR (162 MHz, CD₃OD) is 5-10.31, depicted in accompanying FIG. 1(e) confirms the formation of the current sodium sulfonate mono-CSPhos ligand.
b)¹H NMR data (400 MHz, CD₃OD): δ 7.86 (d, J=2.4 Hz, 1H), 7.82 (dd, J=8.6, 2.3 Hz, 1H), 7.31 (dd, J=8.1, 7.5 Hz, 1H), 7.09 (d, J=8.6 Hz, 1H), 6.94-6.85 (m, 1H), 6.87 (dd, J=8.1, 1.0 Hz, 1H), 4.90 (d, J=1.9 Hz, OH), 4.50 (dd, J=26.0, 12.7 Hz, 1H), 3.83 (s, 3H), 0.68 (d, J=12.0 Hz, 9H). This data as illustrated in accompanying FIG. 1(f) confirms the formation of the sodium sulfonate mono-CSPhos ligand of the present invention.

### Example 2: Evaluation of the New Water-Soluble Sulfonated CSPhos Ligand for its Reactivity Towards Hindered Suzuki-Miyuara Coupling Reactions in Water

Example 2 illustrates the experimental procedure for evaluating the reactivity of the currently developed CSPhos ligand towards the coupling of 1-Bromo-2,4,6-triisopropylbenzene and biphenyl boronic acid in water:
Procedure: A significantly hindered 1-Bromo-2,4,6-triisopropylbenzene (A) ((1.0 mmol) is reacted with biphenyl boronic acid (B) (1.5-4 equiv) in degassed water (1.5 mL mmol −1), in presence of 0.1-1.0 mol % of Palladium (Pd) catalyst [Pd(OAc)₂] and 1.0 mol % of the currently developed water-soluble CS-Phos ligand (L) with 1:1 of Pd: L, at a temperature ranging between 60-100° C. for 4-20 hours. The following reaction scheme 2 is used for the same:

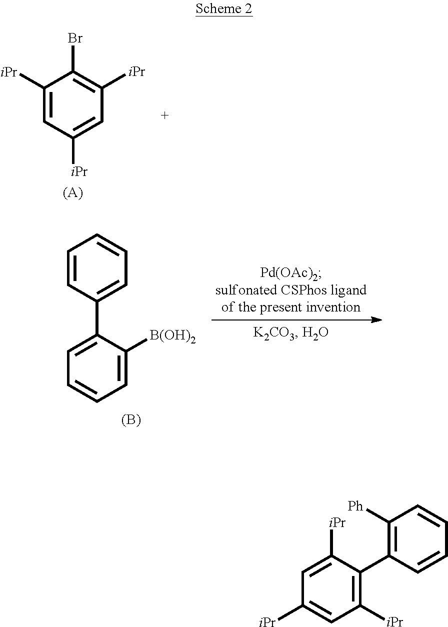

Next, various combinations of the amounts of reactants and/or the other experimental parameters (of scheme 2) are tested in order to select the best working experimental conditions that are required for achieving a complete 100% C-C conversion at an economical rate.

Moreover, the currently developed sulfonate containing phosphine ligand is compared with those of the closest prior arts (as mentioned below) in view of their superior C-C conversion efficacies following same scheme 2:

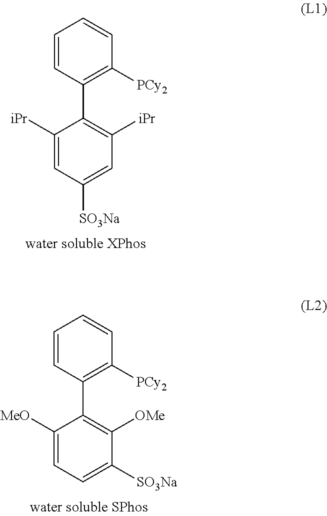

The results obtained by virtue of such experimentations have been provided in the following Table 1 and the same have been discussed in details below:

TABLE 1

| | Biphenyl | | | | | | | | |
|---|---|---|---|---|---|---|---|---|---|
| | boronic acid | | | | Time | | | Amount | |
| Entry | (equiv) | Pd(OAc)₂ | | Ligand | (h) | Solvent | Additive | (equiv) | Conversion |
| 1 | 1.5 | 1 | mol % | s-SPhos | 20 | water | | | 26% |
| 2 | 1.5 | 1 | mol % | s-XPhos | 20 | water | | | 10% |
| 3 | 1.5 | 1 | mol % | CSPhos | 20 | water | — | — | 66% |
| 4 | 4 | 1 | mol % | CSPhos | 4 | water | | | 80% |
| 5 | 1.5 | 1 | mol % | CSPhos | 4 | water | 1,4 | 2.0 eq | 100% |
| | | | | | | | dioxane | | |
| 6 | 1.5 | 0.1 | mol % | CSPhos | 5 | water | 1,4- | 2.0 eq | 100% |
| | | | | | | | dioxane | | |
| 7 | 1.5 | 1 | mol % | CSPhos | 4 | water | TBAB | 0.3 eq | 85% |
| 8 | 3 | 1 | mol % | CSPhos | 4 | water | TBAB | 0.3 eq | 99% |
| 9 | 3 | 0.1 | mol % | CSPhos | 4 | water | TBAB | 0.3 eq | 92% |
| 10 | 3 | 0.1 | mol % | CSPhos | 5 | water | TBAB | 0.3 eq | 100% |
| 11 | 3 | 0.1 | mol % | Mono- | 5 | water | TBAB | 0.3 eq | 88% |
| | | | | CSPhos | | | | | |
| 12 | 3 | 0.1 | mol % | s-SPhos | 5 | water | TBAB | 0.3 eq | 32% |
| 13 | 3 | 0.1 | mol % | s-XPhos | 5 | water | TBAB | 0.3 eq | 8% |
| 14 | 3 | 0.1 | mol % | CSPhos | 5 | water | TDA-1 | 0.3 eq | 71% |
| 15 | 3 | 0.1 | mol % | CSPhos | 5 | water | 18- | 0.3 eq | 15% |
| | | | | | | | Crown-6 | | |
| 16 | 3 | 0.1 | mol % | CSPhos | 5 | water | 15- | 0.3 eq | 55% |
| | | | | | | | crown-5 | | |
| 17 | 3 | 0.1 | mol % | CSPhos | 5 | water | DME | 0.3 eq | 12.4% |
| 18 | 3 | 0.1 | mol % | CSPhos | 5 | water | Diglyme | 0.3 eq | 24.9% |
| 19 | 3 | 0.1 | mol % | CSPhos | 5 | water | triglyme | 0.3 eq | 76% |
| 20 | 3 | 0.1 | mol % | CSPhos | 5 | water | tetraglyme | 0.3 eq | 95% |
| | | | | | | | | | (100^{b}) |

### Results

A. Comparative data showing better working of the currently developed water-soluble CS-Phos ligand in view of the ligands reported in the closest prior arts under suitable parameters:
   i. According to the data shown in entry 1, table 1 above, 1-Bromo-2,4,6-triisopropylbenzene is reacted with 1.5 eq. biphenyl boronic acid in water, in presence of a catalyst i.e. 1.0 mol % of Palladium (Pd) with 1:1 Pd: L, further in presence of the SPhos ligand (L2) reported in prior art, at a temperature of 100° C. for 20 hours:
      The said coupling reaction results into only 26% conversion.
   ii. Further, according to the data shown in entry 2, table 1 above, 1-Bromo-2,4,6-triisopropylbenzene is reacted with 1.5 eq. biphenyl boronic acid in water, in presence of a catalyst i.e. 1.0 mol % of Palladium (Pd) with 1:1 Pd: L, further in presence of the XPhos ligand (L1) reported in prior art, at a temperature of 100° C. for 20 hours:
      The said coupling reaction results into only 10% conversion (low conversion).
   iii. Further, according to the data shown in entry 3, table 1 above, 1-Bromo-2,4,6-triisopropylbenzene is reacted with 1.5 eq. biphenyl boronic acid in water, in presence of a catalyst i.e. 1.0 mol % of Palladium (Pd) with 1:1 Pd: L, further in presence of the currently developed CSPhos ligand at a temperature of 100° C. for 20 hours.
      The said coupling reaction in presence of the currently developed CSPhos ligand provided a better conversion rate of 66%.
   iv. Further, according to the data shown in entry 4, table 1 above, the amount of the reactant biphenyl boronic acid is increased from 1.5 eq. to 4 eq. and reacted with 1-Bromo-2,4,6-triisopropylbenzene in water, in presence of a catalyst i.e. 1.0 mol % of Palladium (Pd) with 1:1 Pd: L, further in presence of the currently developed CSPhos ligand at a temperature of 100° C. for 4 hours:
      The said coupling reaction surprisingly provided a good conversion rate of 80% after 4 hours at 100° C.
   v. Further, according to the data shown in entries 5-6, table 1 above, under similar experimental set up as above (iii), the inventors of the present invention altered the solvent system and checked the results. Both substrates being hydrophobic in nature, a small amount of dioxane i.e. around 2 eq. is added to water. As a result, a complete 100% conversion of 1-Bromo-2,4,6-triisopropylbenzene is observed within 4 hours when reacted with 1.5 equiv of biphenyl boronic acid. Furthermore, it has been observed that even when the catalyst loading is decreased to only 0.1 mol % Pd, then also a complete 100% conversion rate is achieved after 4-5 hours at 100° C. using water-dioxane solvent system. This experiment is for a comparative analysis of solvent effect on the reaction.
B. Further, the inventors of the present invention have additionally used a Phase Transfer Catalyst (PTC) in the same reaction scheme 2 (as above) in order to achieve complete C-C conversions. The results obtained are discussed below:
   vi. According to the data shown in entry 7, table 1 above, 1-Bromo-2,4,6-triisopropylbenzene is reacted with 1.5 eq. biphenyl boronic acid in water, in presence of a catalyst i.e. 1.0 mol % of Palladium (Pd) with 1:1 Pd: L, further in presence of the currently developed CSPhos ligand, and also in presence of tetra-N-butyl ammonium bromide (TBAB) as PTC (0.3 eq.) at a temperature of 100° C. for 4 hours:
      The said coupling reaction in presence of a 0.3 eq. phase transfer catalyst TBAB, provided 85% conversion after 4 hours at 100° C. with complete consumption of boronic acid.
   vii. Further, according to the data shown in entry 8, table 1 above, when the amount of biphenyl boronic acid is doubled to 3 eq., and rest of the reaction parameters are maintained as above (vi), then the following result is obtained:
      The said coupling of significantly hindered 1-Bromo-2,4,6-triisopropylbenzene with 3 eq. of boronic acid, using 1.0 mol % of Pd catalyst with 1:1 Pd: L, in presence of a 0.3 eq. phase transfer catalyst TBAB results in 99% conversion.
   viii. Further, according to the data shown in entry 9, table 1 above, when the amount of the Pd catalyst loading is reduced to 0.1 mol %, and rest of the reaction parameters are maintained as above (vii), then the following result is obtained:
      The coupling of significantly hindered 1-Bromo-2,4,6-triisopropylbenzene with 3 eq. of boronic acid, using 0.1 mol % of Pd catalyst with 1:1 Pd: L, in presence of a 0.3 eq. phase transfer catalyst TBAB, results into a 92% conversion at a temperature of 100° C. for 4 hours.
   ix. Further, according to the data shown in entry 10, table 1 above, when the reaction time is increased to 5 hours from 4 hours and rest of the reaction parameters are maintained as above (viii), then the following result is obtained:
      The coupling of significantly hindered 1-Bromo-2,4,6-triisopropylbenzene with 3 eq. of boronic acid at a lower catalyst loading of 0.1 mol % Pd catalyst with 1:1 Pd: L, in presence of a 0.3 eq. phase transfer catalyst TBAB, surprisingly results into a complete 100% conversion.
   x. Further, according to the data shown in entry 11, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed mono-CSPhos ligand, and also in present of TBAB as PTC (0.3 eq.) at a temperature of 100° C. for 5 hours::
      The said coupling reaction resulted into 88% conversion.
   xi. Further, according to the data shown in entries 12-13, table 1 above, in the above experimental set up (x), the reportedly known ligands XPhos (L1) and SPhos (L2) are used in place of the currently developed CSPhos for a comparative analysis. The following results are obtained:
      The said coupling reactions results into poor conversions of 8% and 32% using L1 and L2 respectively.

Therefore, by increasing the time at a lower Pd catalyst loading (only 0.1 mol %), the inventors of the present invention have obtained the most suitable reaction parameters for Suzuki coupling reactions using the sulfonate containing CSPhos and mono-CSPhos ligands of the present invention that could achieve a 100% and 88% C-C conversion respectively in a very economical way. Further, a comparative analysis (as mentioned in experiment xi above) clearly shows that the currently developed ligands are capable of providing superior C-C conversion rates (99-100%) over those reported by the known sulfonated ligands of the prior arts. Therefore, since, the currently developed CSPhos ligand provides a cost-effective C-C conversion with 100% accuracy; hence, is suitable for similar industrial level scale-up reactions in pharmaceutical industries for API (Active Pharmaceutical Ingredients) or NCE (New Chemical Entity) developments.

### Example 3: Analysis of the Reactivity Profiles of the Currently Developed Sulfonated Phosphine Ligand (CSPhos) in Presence of Various Phase Transfer Catalysts (PTCs) Under the Best Working Reaction Conditions

Example 3 further illustrates the reactivity profiles of the currently developed sulfonated phosphine ligand (CSPhos) in presence of various Phase Transfer Catalysts (PTCs) under the best working reaction conditions as obtained from the experiment (ix) above. Such experimentation provides an innovative way of conducting various Suzuki type coupling reactions at industrial scales.
Procedure: A coupling reaction of a very hindered 1.0 eq. 1-Bromo-2,4,6-triisopropylbenzene with 3.0 eq. biphenyl boronic acid is conducted in degassed water (1.5 mL mmol ⁻¹), in presence of the currently developed 0.1 mol % of ligand CSPhos, further in presence of a catalyst i.e. 0.1 mol % of Palladium (Pd) with 1:1 Pd: L, and a 0.3 eq. phase transfer catalyst (additive) such as tetrabutyl ammonium bromide (TBAB), tetrabutyl ammonium iodide, tetrabutyl ammonium chloride, tetrabutyl ammonium hexafluorphosphate and other quaternary amine salts, Triethanolamine tris(2-methoxyethyl) ether (TDA-1), 18-Crown-6, 15-crown-5, Dimethoxyethane (DME), glyme, Diglyme, Triethylene glycol dimethyl ether (Triglyme), Tetraethylene glycol dimethyl ether (Tetraglyme), 1,4-Dioxane, tetrahydrofuran, at a temperature of 100° C. for 5 hours.
Results: The results obtained have been described below:
   xii. Further, according to the data shown in entry 14, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of TDA-1 as PTC (0.3 eq.) at a temperature of 100° C. for 5 hours:
      The said coupling reaction results into 71% conversion.
   xiii. Further, according to the data shown in entry 15, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of 18-Crown-6 as PTC (0.3 eq.) at a temperature of 100° C. for 5 hours:
      The said coupling reaction results into 15% conversion.
   xiv. Further, according to the data shown in entry 16, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of 15-crown-5 as PTC (0.3 eq.) at a temperature of 100° C. for 5 hours:
      The said coupling reaction results into 55% conversion.
   xv. Further, according to the data shown in entry 17, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of DME as PTC (0.3 eq.) at a temperature of 100° C. for 5 hours:
      The said coupling reaction results into 12.4% conversion.
   xvi. Further, according to the data shown in entry 18, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of Diglyme as PTC (0.3 eq.) at a temperature of 100° C. for 5 hours:
      The said coupling reaction results into 24.9% conversion.
   xvii. Further, according to the data shown in entry 19, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of Triglyme as PTC (0.3 eq.) at a temperature of 100° C. for 5 hours:
      The said coupling reaction results into 76% conversion.
   xviii. Further, according to the data shown in entry 20, table 1 above, 1-Bromo-2,4,6-triisopropylbenzene is reacted with 3 eq. biphenyl boronic acid in water, in presence of a catalyst i.e. 0.1 mol % of Palladium (Pd) with 1:1 Pd: L, further in presence of the currently developed CSPhos ligand, and also in present of Tetraglyme as PTC (0.3 eq.) at a temperature of 100° C. for 5 hours:
      The said coupling reaction results into 95-100% conversion within 5 hours. Further, it has been observed that when this experimental set up is left for 7 hours, it results into 100% conversion with Tetraglyme.

### Example 4: Modified C-C Coupling Reaction Procedure Using Tetraglyme as Additive

In continuation to the above experiments done in example 3 above, the inventors of the present invention has further observed in Example 4 that when Tetraglyme is used as an additive (PTC), a complete consumption of boronic acid is not achieved; whereas, when TBAB is used as the PTC, an amount of 3.0 equiv of boronic acid is required to compensate for the proto-deboronation (as shown in entry 8, table 1 above). Therefore, the inventors of the present invention have conducted the same reaction with 1.5 equiv of boronic acid as shown respectively in scheme 3 below:
Procedure:

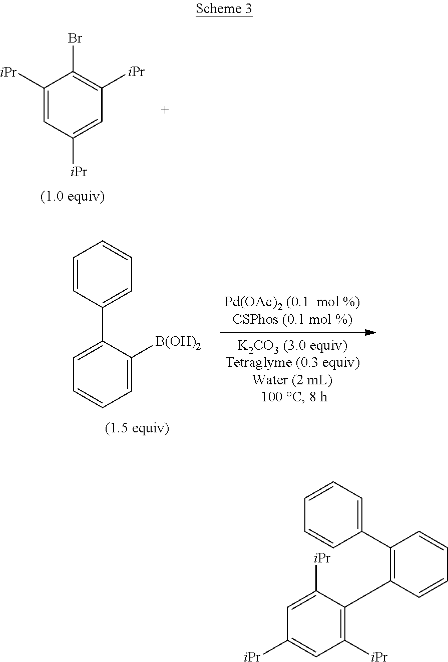

A coupling reaction of a very hindered 1.0 eq. aryl bromide (1-Bromo-2,4,6-triisopropylbenzene) with 1.5 eq. biphenyl boronic acid is conducted in degassed water (1.5 mL mmol⁻¹), in presence of 3.0 equiv K₂CO₃, using the currently developed 0.1 mol % of CSPhos ligand, further in presence of a catalyst i.e. 0.1 mol % of Palladium (Pd) with 1:1 Pd: L, and 0.3 eq. phase transfer catalyst Tetraglyme, at a temperature of 100° C. for 8 hours (as shown in scheme 3 above).
Results: This reaction in scheme 3 above results in a complete (100%) conversion of the alkyl halide (1.0 eq. 1-Bromo-2,4,6-triisopropylbenzene) within 8 hours at 100° C. Therefore, it has been confirmed that tetraglyme as PTC promotes this hindered coupling reaction and mitigates the proton deboronation.

### Example 5: Suzuki-Miyaura Coupling of Aryl Halides Using CSPhos in the Presence of TBAB or Tetraglyme as PTC

Combining the best suitable reaction conditions as observed above in Examples 2-4, the inventors of the present invention have further examined the reactivity profiles of the currently developed CSPhos ligand towards various hindered coupling substrates like sterically congested aryl halides, heteroaryl arylboronic acids and compounds containing heteroatom moieties, with various arylboronic acids, in presence of a low Pd catalyst loading of 0.1 mol % and essentially in presence TBAB or Tetraglyme as PTC (0.3 eq.) in water, as described in scheme 4 below:

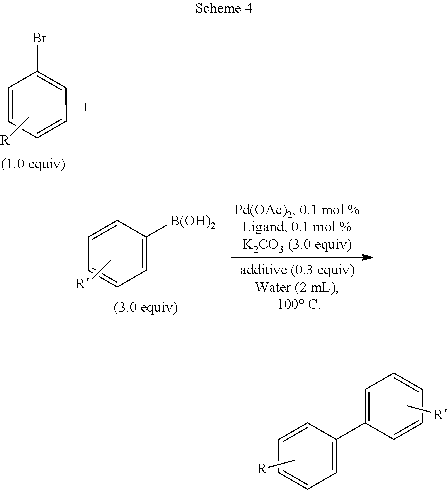

Procedure: A sterically hindered aryl bromide (1.0 e.q.) is coupled with an arylboronic acid (3 e.q.) in degassed water (1.5 mL mmol −1), in presence of a low Pd catalyst loading of 0.1-1.0 mol % and essentially in presence TBAB or Tetraglyme as PTC (0.3 eq.) in water, further essentially in presence of the current CSPhos ligand in a ligand: catalyst ratio of 1:1, which provided the results as depicted in the accompanying FIG. 2 and the same have been discussed in details below:

### Results

a) The couplings reactions with TBAB as PTC provides excellent coupling products with excellent yields as shown in accompanying FIG. 2, entries 3a-3h.
b) The couplings reactions with Tetraglyme as PTC provides excellent coupling products in excellent yields as shown in accompanying FIG. 2, entries 4a-4o. When the heteroatom substrates used in this experiment is selected from a group consisting of pyridine (accompanying FIG. 2, entries 4c,4e) the yield is 92-94%, on indoles (accompanying FIG. 2, entries 4j,4k) the yield is 77-78%, on quinolines (accompanying FIG. 2, entries 4b,4k) the yield is around 77-93%, on dibenzothiophenes (accompanying FIG. 2, entries 4i,4j) the yield is 78-86%, and on amines (accompanying FIG. 2, entries 41) the yield is around 86%. It has further been observed that Thianthrenylboronic acid coupling with phenyl esters also gave excellent yields of 90-98% (accompanying FIG. 2, entries 4g, 4h). Furthermore, the currently developed ligand under the best experimental conditions when applied on some more complex heteroatom containing substrates (as shown in accompanying FIG. 2, entries 4m, 4o) provides excellent coupling products with superior yields (around 92-96%).

### Example 6: Synthesis of Commercially Available Molecule Boscalid in 1.0 Gram (Industrial) Scale

Example 6 illustrates the synthesis of commercially available molecule Boscalid in 1.0 gram (industrial) scale by means or utilizing the present Suzuki-Miyaura couplings reaction technique, essentially involving the currently developed CSPhos ligands for producing commercially available molecule Boscalid in 1.0 gram (industrial) scale, as shown in scheme 5 below:

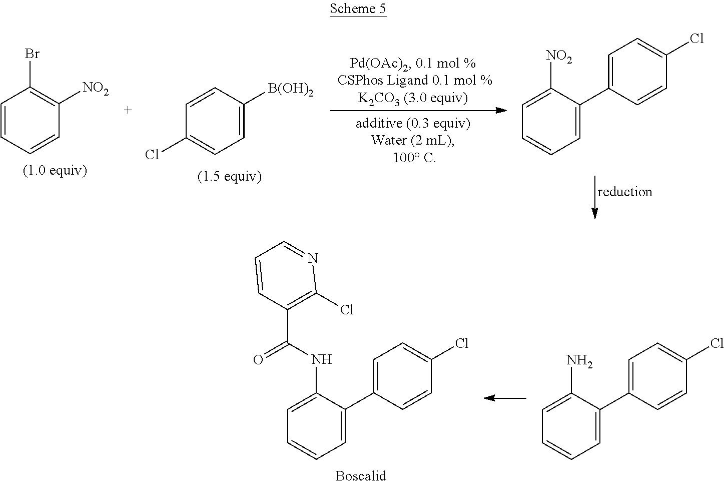 [SMILES: O=[N+]([O-])c1ccccc1Br ; OB(O)c1ccc(Cl)cc1 ; O=[N+]([O-])c1ccccc1-c1ccc(Cl)cc1 ; O=C(Nc1ccccc1-c1ccc(Cl)cc1)c1cccnc1Cl ; Nc1ccccc1-c1ccc(Cl)cc1]

Procedure: A reaction vessel is charged with a sterically hindered nitro-aryl bromide i.e. 1-Bromo-2-nitrobenzene 1.0 g (4.950 mmol), a chloro-arylboronic acid i.e. 4-chlorophenylboronic acid (1.2 g, 7.42 mmol), catalyst Pd(OAc)2 (1.1 mg, 0.00495 mmol), the currently developed ligand CS-Phos (2.2 mg, 0.00495 mmol) [ligand: catalyst ratio of 1:1], K₂CO₃ (2.1 g, 14.85 mmol), additive tetraglyme (0.34 mg, 1.485 mmol) and water (20.0 mL). The reaction mixture is stirred at 105° C. for 16 h. After completion of the reaction (TLC), the reaction mixture is extracted with DCM (2×5.0 mL) and the combined organics are washed with water (3×5.0 mL), dried over Na2SO4, and concentrated under vacuum to obtain the crude product. The crude product is purified by column chromatography (silica gel, 10% EtOAc/hexanes) to afford the desired product in 1.0g as light-yellow oil.

### Results

a) Industrial level Boscalid is synthesized in 1.0-gram scale with a yield of around 87%.

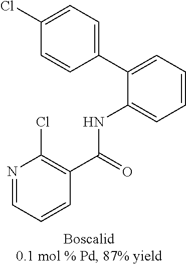 [SMILES: O=C(Nc1ccccc1-c1ccc(Cl)cc1)c1cccnc1Cl]

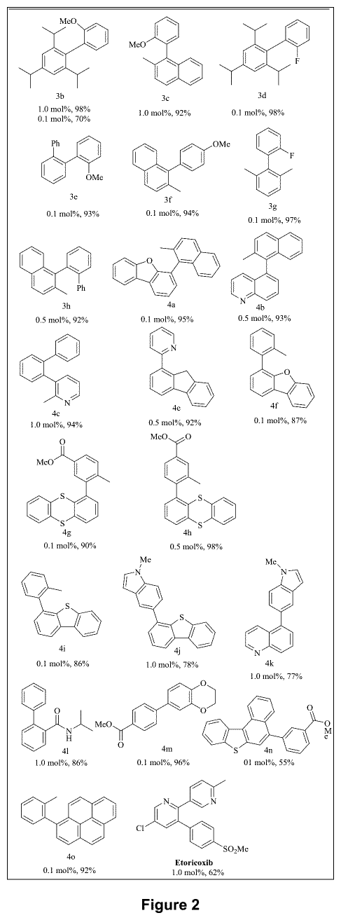

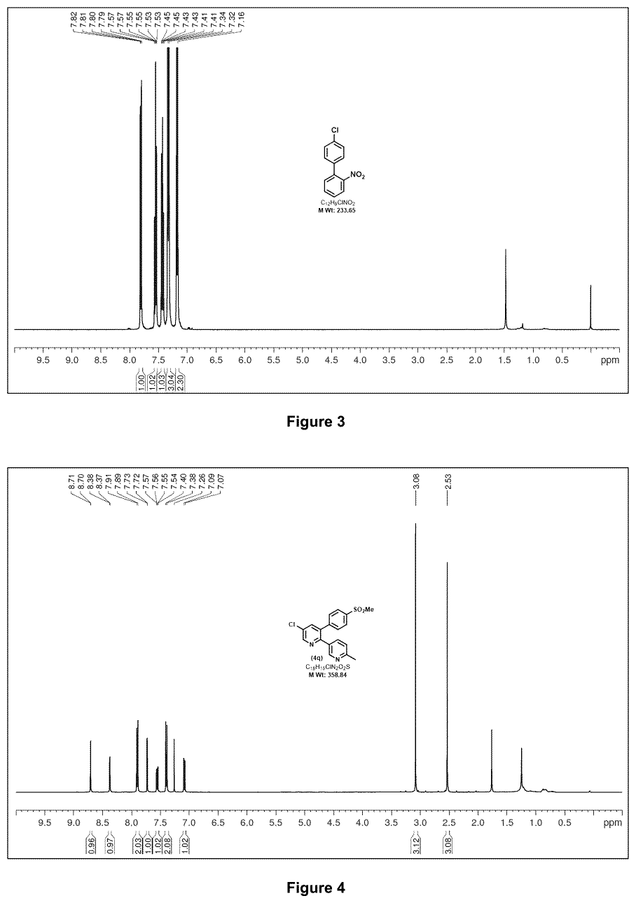

The following spectral data obtained confirms the formation of the said product.
b) The accompanying FIG. 3 graphically illustrates the ¹H NMR data (400 MHz, CDCl3) which shows δ=7.81 (dd, J=8.1, 1.4 Hz, 1H), 7.55 (td, J=7.6, 1.3 Hz, 1H), 7.47-7.40 (m, 1H), 7.35-7.30 (m, 3H), 7.22-7.14 (m, 2H). This ¹H NMR data confirms the formation of Boscalid.

### Example 7: Synthesis of Commercially Available Molecule Etoricoxib, a Selective COX-2 Inhibitor in 200 mg Scale

Example 7 illustrates the synthesis of commercially available molecule Etoricoxib, a selective COX-2 inhibitor in 200 mg scale by means or utilizing the present Suzuki-Miyaura couplings reaction technique, essentially involving the currently developed CSPhos ligands for producing commercially available molecule Etoricoxib, a selective COX-2 inhibitor in 1.0 gram (industrial) scale, as shown in scheme 6 below:

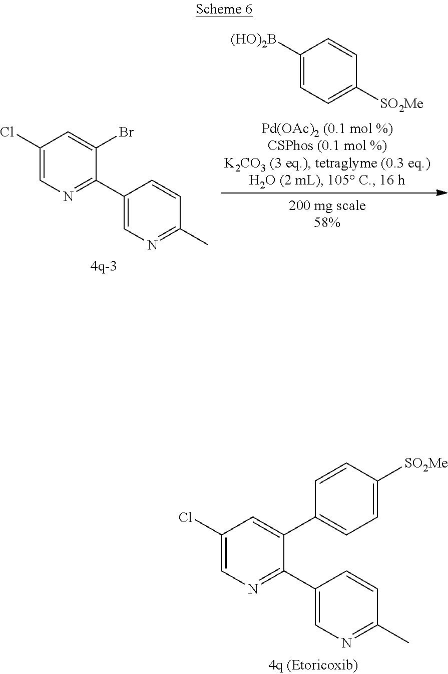 [SMILES: CS(=O)(=O)c1ccc(B(O)O)cc1 ; Cc1ccc(-c2ncc(Cl)cc2Br)cn1 ; Cc1ccc(-c2ncc(Cl)cc2-c2ccc(S(C)(=O)=O)cc2)cn1]

Procedure: A 10 mL reaction vessel is charged with 4-(methanesulfonyl)phenylboronic acid (0.21 mg, 1.058 mmol, 1.5 equiv), bipyridine 4q-3 (0.2 mg, 0.71 mmol, 1 equiv.), catalyst Pd(OAc)₂ (0.2 mg, 0.7 μmol, 0.1 mol %), the currently developed CS-Phos ligand (0.31 mg, 0.69 μmol, 0.1 mol %), K₂CO₃ (0.29 mg, 2.12 mmol, 3 equiv.), tetraglyme (45 mL, 0.21 mmol, 0.3 equiv) and degassed water (2.0 mL) under nitrogen. The reaction vessel is sealed with a crimper, and the reaction mixture is stirred at 105° C. for 18 h. After completion of the reaction (LCMS), the reaction mixture is cooled to room temperature, and extracted with EtOAc (2×5.0 mL). The combined organic layers are washed with water (3×5 mL), dried over Na₂SO₄, and concentrated under reduced pressure. The crude product is purified by flash column chromatography (EtOA:hexanes=1:1, then 4:1) to give Etoricoxib (4q) as a white solid (147.0 mg).

### Results

a) Industrial level Etoricoxib is synthesized in 200 mg scale with a yield of around 58%.

The spectral data obtained confirms the formation of the product below:
b) The accompanying FIG. 4 graphically illustrates the ¹H NMR data (400 MHz, CDCl3) which shows δ=8.71 (d, J=2.3 Hz, 1H), 8.37 (d, J=2.2 Hz, 1H), 7.90 (d, J=8.4 Hz, 2H), 7.73 (d, J=2.3 Hz, 1H), 7.55 (dd, J=8.0, 2.3 Hz, 1H), 7.39 (dt, J=8.4 Hz, 2H), 7.08 (d, J=8.1 Hz, 1H), 3.08 (s, 3H), 2.53 (s, 3H). This ¹H NMR confirms the formation of Etorocoxib.
c) MS(ESI): calcd for C₁₈H₁₅ClN₂O₂S [M+H]⁺ 359.8; further confirms formation of Etorocoxib.

We claim:

1. A water-soluble phosphorous ligand of formula (I) and racemates, enantiomers, atrop-diastereomers and pharmaceutical salts thereof, for a Pd-catalyzed sterically hindered Suzuki-Miyaura Coupling reaction in aqueous media: 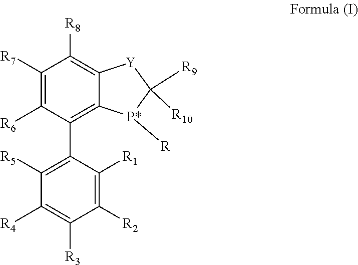
wherein, R is (C₁-C₆)-alkyl, CF₃, (C₃-C₁₀)-carbocyclyl, (5 to 11-membered)heterocarbocyclyl, (C₆-C₁₀)aryl, (5 to 11-membered)heteroaryl, ferrocenyl, wherein each such carbocyclyl, heterocarbocyclyl, aryl, ferrocenyl or heteroaryl group is optionally substituted with 1 to 3 substituents independently selected from the group consisting of H, —O—(C₁-C₆)alkyl, (C₁-C₆)alkyl, and CF₃;
P* is a chiral centre;
Y is O, S, CH2, NRₐ, SO₂R_{b},
wherein Rₐ is alkyl, aryl, heteroaryl, acyl preferably tert-butylacyl;
further wherein R_{b} is alkyl, aryl, heteroaryl;
R1, R2, R3, R4, R5, R6, R7, R8, R9 and R10 is each independently selected from a group consisting of H, halo, CF3, a sulfonyl moiety, (C₁-C₆)-alkyl, —O—(C₁-C₆)-alkyl, (C₆-C₁₀)aryl, —O—(C₆-C₁₀)aryl, (C₅-C₁₁) heteroaryl, —O—(C₅-C₁₀) heteroaryl, wherein each such alkyl, aryl or heteroaryl group is optionally substituted with 1 to 3 substituents independently selected from the group consisting of H, (C₁-C₆)-alkyl, halo, —O—(C₁-C₆)alkyl and CF₃; further wherein, at least any one of R1, R2, R3, R4, R5, R6, R7, R8, R9 and R10 is essentially a sulfonyl moiety of formula (X) 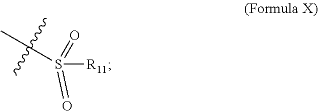
wherein R11 is —O or N or a metal atom;
further substituted with a substituent selected from a group consisting of H, a metal atom, substituted or unsubstituted (C₁-C₆)alkyl, substituted or unsubstituted (C₆-C₁₀)aryl, substituted or unsubstituted (C₅-C₁₁)heteroaryl, NRₓR_{y}R_{z}, (C₁-C₆)alkyl-NRₓR_{y}R_{z};
further wherein,
said metal atom is an alkali metal atom, preferably Li, Na, K, Cs; and
each one of Rₓ, R_{y} and R_{z} is H, halo, CF3, (C₁-C₆)-alkyl, —O—(C₁-C₆)-alkyl, (C₆-C₁₀)aryl, (C₅-C₁₁) heteroaryl, —O—(C₅-C₁₁) heteroaryl
or
Rₓ, R_{y} and R_{z} taken together with the adjacent N atom can form a 5-11 membered heterocylic ring system which can further be substituted with H, (C₁-C₆)-alkyl, halo, —O—(C₁-C₆)alkyl and CF3.

2. The water-soluble phosphorous ligand in accordance with claim 1, wherein said Y is O.

3. The water-soluble phosphorous ligand in accordance with claim 1, wherein said R is (C₁-C₆)-alkyl selected from —CH₃, —CH₂—CH₂, —CH(CH₃)₂, —C(CH₃)₃, —C(CH₂CH₃)₃ and —C(CH₂CH₃)(CH₃)₂, preferably —C(CH₃)₃.

4. The water-soluble phosphorous ligand in accordance with claim 1, wherein said R1, R2, R3, R4, R5, R6, R7, R8, R9 and R10 is —(C₁-C₆)-alkyl or —O—(C₁-C₆)-alkyl, preferably —CH₃, —CH₂CH₃, —CH(CH₃)₂ or —O—CH₃, with a condition such that at least any one of the other R1, R2, R3, R4, R5, R6, R7, R8, R9 and R10 is essentially a sulfonyl moiety of formula (X)

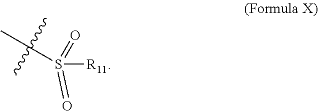

5. The water-soluble phosphorous ligand in accordance with claim 4, wherein R11 is O which is further substituted with a substituent selected from a group consisting of H, a metal atom, substituted or unsubstituted (C₁-C₆)alkyl, substituted or unsubstituted (C₆-C₁₀)aryl, substituted or unsubstituted (C₅-C₁)heteroaryl, NRₓR_{y}R_{z}, (C₁-C₆)alkyl-NRₓR_{y}R_{z};
further wherein,
said metal atom is an alkali metal atom, preferably Li, Na, K, Cs; and
each one of Rₓ, R_{y} and R_{z} is H, halo, CF3, (C₁-C₆)-alkyl, —O—(C₁-C₆)-alkyl, (C₆-C₁₀)aryl, (C₅-C₁₁) heteroaryl, —O—(C₅-C₁₁) heteroaryl
or
Rₓ, R_{y} and R_{z} taken together with the adjacent N atom can form a 5-11 membered heterocyclic ring system which can further be substituted with H, (C₁-C₆)-alkyl, halo, —O—(C₁-C₆)alkyl and CF3.

6. The water-soluble phosphorous ligand in accordance with claim 5, wherein R11 is O which is further substituted with an alkali metal atom selected from Li, Na, K and Cs.

7. A sterically hindered Suzuki-Miyaura Coupling process in aqueous media comprising the steps of:
a) reacting two sterically hindered substrates in presence of a Palladium (Pd)-based catalyst;
b) essentially adding the water-soluble phosphorous ligand of formula (I) 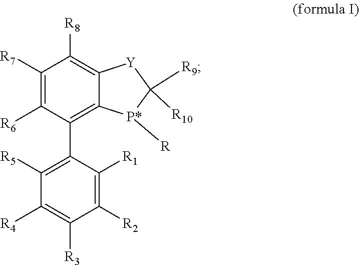
wherein R, R1, R2, R3, R4, R5, R6, R7, R8, R9, R10 and Y have same attributes in accordance with claim 1; further
c) adding abase;
d) adding a Phase Transfer catalyst (PTC); and
e) water.

8. The process in accordance with claim 7, wherein said sterically hindered substrates are selected from a group consisting of aryl halide, arylboronic acid and heteroaryl halides.

9. The process in accordance with claim 8, wherein said sterically hindered substrates are selected from a group consisting of 1-bromo-2,4,6-triisopropylbenzene, 1-bromo-2-nitrobenzene, 1-bromo-2-methylnaphthalene, methyl-2-bromo-3-methylbenzoate, 2-bromo-1,3,5-triisopropylbenzene, 2-bromo-1,3,5-tri-tert-butylbenzene, [1,1′-biphenyl]-2-ylboronic acid, 2-fluoro-6-methoxyphenyl-boronic acid, thianthren-1-ylboronic acid, 2,6-dimethylphenyl-boronic acid, and 2-bromopyridine.

10. The process in accordance with claim 7, wherein said Palladium (Pd)-based catalyst is selected from a group consisting of Pd(OAc)₂, Pd₂(dba)₃, Pd(PPh₃)₄ and palladacycles.

11. The process in accordance with claim 7, wherein said base is selected from K₂CO₃, K₃PO₄, Na₂CO₃ or NA₃PO₄.

12. The process in accordance with claim 7, wherein said Phase Transfer Catalyst (PTC) is selected from a group consisting of tetrabutyl ammonium bromide (TBAB), tetrabutyl ammonium iodide, tetrabutyl ammonium chloride, tetrabutyl ammonium hexafluorphosphate and other quaternary amine salts, Triethanolamine tris(2-methoxyethyl) ether (TDA-1), 18-Crown-6, 15-crown-5, Dimethoxyethane (DME), glyme, Diglyme, Triethylene glycol dimethyl ether (Triglyme), Tetraethylene glycol dimethyl ether (Tetraglyme), 1,4-Dioxane and Tetrahydrofuran.

13. The process in accordance with claim 7, wherein said water-soluble phosphorous ligand is selected from:

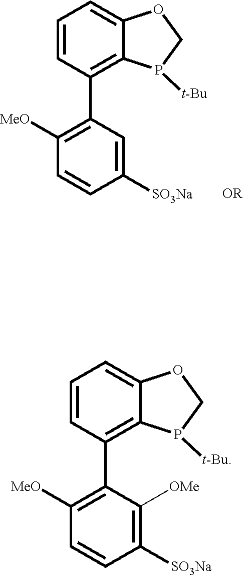

14. The process in accordance with claim 7, wherein said ligand is loaded in a minimal amount ranging between 0.1 and 1.0 mol %.

15. The process in accordance with claim 7, wherein said Pd based catalyst is loaded in a minimal amount ranging between 0.1 and 1.0 mol % Palladium.

16. The process in accordance with claim 7, wherein the catalyst to ligand loading ratio ranges between 1:1 and 1:2.

17. The process in accordance with claim 7, wherein said process provides 90-100% C-C conversion.

18. A water-soluble phosphorous ligand for sterically hindered Suzuki-Miyaura Coupling reaction is selected from: [chemical structure]
